(19) United States
(12) Patent Application Publication
(10) Pub. No.: US 2014/0074562 A1
(43) Pub. Date: Mar. 13, 2014

(54) CONFIGURABLE RATING AND METERING

(71) Applicants: YU DENG, Yorktown Heights, NY (US); Alexei Karve, Yorktown Heights, NY (US); Andrzej Kochut, Yorktown Heights, NY (US); Randy Allan Rendahl, Yorktown Heights, NY (US); Anca Sailer, Yorktown Heights, NY (US); Hidayatullah Habeebullah Shaikh, Yorktown Heights, NY (US)

(72) Inventors: YU DENG, Yorktown Heights, NY (US); Alexei Karve, Yorktown Heights, NY (US); Andrzej Kochut, Yorktown Heights, NY (US); Randy Allan Rendahl, Yorktown Heights, NY (US); Anca Sailer, Yorktown Heights, NY (US); Hidayatullah Habeebullah Shaikh, Yorktown Heights, NY (US)

(73) Assignee: International Business Machines Corporation, Armonk, NY (US)

(21) Appl. No.: 13/613,828

(22) Filed: Sep. 13, 2012

Related U.S. Application Data
(62) Division of application No. 13/612,481, filed on Sep. 12, 2012.

(51) Int. Cl. G06Q 10/06

(52) U.S. Cl. 705/7.39

(57) ABSTRACT

A method for creating a configurable model for rating and metering resource usage, the method includes utilizing at least one rating context for a contract of a registered offering, wherein the registered offering is a resource, monitoring the resource usage to create a usage record, optimizing the collection of the usage data based on revenue potential and metering costs, contextualizing a usage record of the resource, generating rated usage data according to the usage record, and tuning a performance indicator of a metering definition for the registered offering based on the rated usage data.

### CROSS-REFERENCE TO RELATED APPLICATION

This is continuation application of U.S. application Ser. No. 13/612,481, filed Sep. 12, 2012, the disclosure of which is herein incorporated by reference in its entirety.

### BACKGROUND

1. Technical Field

The present disclosure generally relates to rating and metering, and more particularly, to a model for rating and metering that includes the cost function for the metering of metrics.

2. Discussion of Related Art

Metering refers to the ability of an organization to track and measure consumption in a business context. Here, consumption refers to, for example, access to processing resources. The business context may be a unit or project.

Rating models can require complex metering capabilities, which may be costly to develop and run in steady state. The rating models attempt to define feasible and cost effective solutions for metering consumption of a resource. The rating models are typically created manually by a team of experts.

Therefore, a need exists for an automated method of optimizing a rating model that balances the cost of metering against a change in a business value.

### BRIEF SUMMARY

According to an embodiment of the present disclosure, a method for a computer having at least one processor for utilizing a configurable model for rating and metering resource usage includes analyzing at least one rating context for a contract of a registered offering, optimizing the collection of the usage data based on revenue potential, wherein the registered offering is a resource, monitoring the resource usage to create a usage record, contextualizing a usage record of the resource, generating rated usage data according to the usage record, and tuning a performance indicator of a metering definition for the registered offering based on the rated usage data.

According to an embodiment of the present disclosure, a method for a computer having at least one processor for optimizing a configurable model for rating and metering resource usage includes monitoring at least one rating context for a contract of a registered offering, wherein the registered offering is a resource, contextualizing a usage record of the resource, generating rated usage data according to the usage record, and optimizing a cost of generating the rated usage data and a revenue generated by the registered offering.

According to an embodiment of the present disclosure, methods described here may be embodied in a computer program product for creating a configurable model for rating and metering resource usage. The computer program product may include computer readable storage medium having computer readable program code embodied therewith, that when executed by a processor perform methods steps.

### BRIEF DESCRIPTION OF THE SEVERAL VIEWS OF THE DRAWINGS

Preferred embodiments of the present disclosure will be described below in more detail, with reference to the accompanying drawings:

FIG. 1 is a flow diagram of a method for cost characteristic definition according to an embodiment of the present disclosure;

FIG. 2 is a flow diagram of a method for metering optimization and charge characteristic definition according to an embodiment of the present disclosure;

FIG. 3 is flow diagram of rating service functionality according to an embodiment of the present disclosure;

FIG. 4 is a flow diagram of a bootstrap method of FIG. 3;

FIG. 5 is a flow diagram of a rating context creation and rating method of FIG. 3;

FIG. 6 is a table exemplifying the rating context creation and rating execution according to be an embodiment of the present disclosure;

FIG. 7 is a cloud computing environment providing billing service functionality according to be an embodiment of the present disclosure; and

FIG. 8 is a diagram of a computer system for configurable models rating and metering according to an embodiment of the present disclosure.

### DETAILED DESCRIPTION

According to an embodiment of the present disclosure, a function may be used to modify or optimize control parameters including a cost of collecting metrics supporting billing and revenue associated with a metered quantity. The function may include control parameters for other system considerations such as responsiveness and the stability of the system. The function may be expressed and optimized for certain system characteristics.

The system characteristics may optimize a net benefit based on the control parameters. An exemplary net benefit may be expressed as a profit generated from metered charges minus a cost of metering system and a cost of system responsiveness degradation, etc.

The control parameters include, for example, metering frequency (e.g., collection of hourly samples versus daily samples) or a degree of detail of the metered value (e.g., exact processor and memory usage of a virtual machine (VM) or a number of hours a VM existed). The variation in these control parameters may affect both the revenue and cost.

In the case of revenue for example, if a sampling rate is low and a resource changes an owner within a sample period, a provider may need to forgo the revenue associated with the usage. In the case of cost, a higher sampling rate may need a more expensive monitoring system.

According to an embodiment of the present disclosure, an output of the function may be optimized to take the control parameters into account and determine a metering policy that attempts to maximize a net gain for a service provider.

According to an embodiment of the present disclosure, rating models may be implemented in various contexts to impart metering capabilities. For example, rating models may be used in the field of information technology services, for example,

Software as a Service (SaaS), Platform as a Service (PaaS), and Infrastructure as a Service (IaaS). The rating models may be based on metering of processor load, input/output (IO) processes, bandwidth utilization, virtual machine time, and the like. Other exemplary fields include online service deployment (e.g., using a rating model for determining charge-backs under the terms of a license), user behavior (e.g., based on a user's connection time or the number of users connected to a server), and electronic storage. The rating model may be used to define feasible and cost effective solutions.

According to an embodiment of the present disclosure, a policy based framework is described in which a cost of metering may be represented for varying metrics. Within the policy based framework dependencies of a rating model on metering subsystem may be modeled. The policy based framework includes optimization logic for quantifying a tradeoff between a cost of gathering the metering data and charges collected. The charges may include revenue generally, and more particularly, chargebacks, royalties, etc. The tradeoff may be controlled for different outcomes, for example, to maximize net revenue, reduce risk, reduce cost, etc.

Embodiments of the present disclosure will be described in terms of metering processor resources. It should be understood that concepts described herein are applicable to a variety of fields and that the present disclosure is not limited to exemplary embodiments described here and may include information technology, risk optimization, financial metrics, etc.

According to an embodiment of the present disclosure, metering templates may be defined. The metering template definition includes associated costs. For example, a cost of gathering the information may be defined as a function for each metered value in a template. The function may have multiple different factors that affect an actual cost value output by the function. An exemplary factor includes a cost that varies with a frequency of data collection (e.g., processor time or network bandwidth incurred for each data collection event). It should be understood that various different factors may be defined. According to an embodiment of the present disclosure, a library may be created including a plurality of metering artifacts and associated costs.

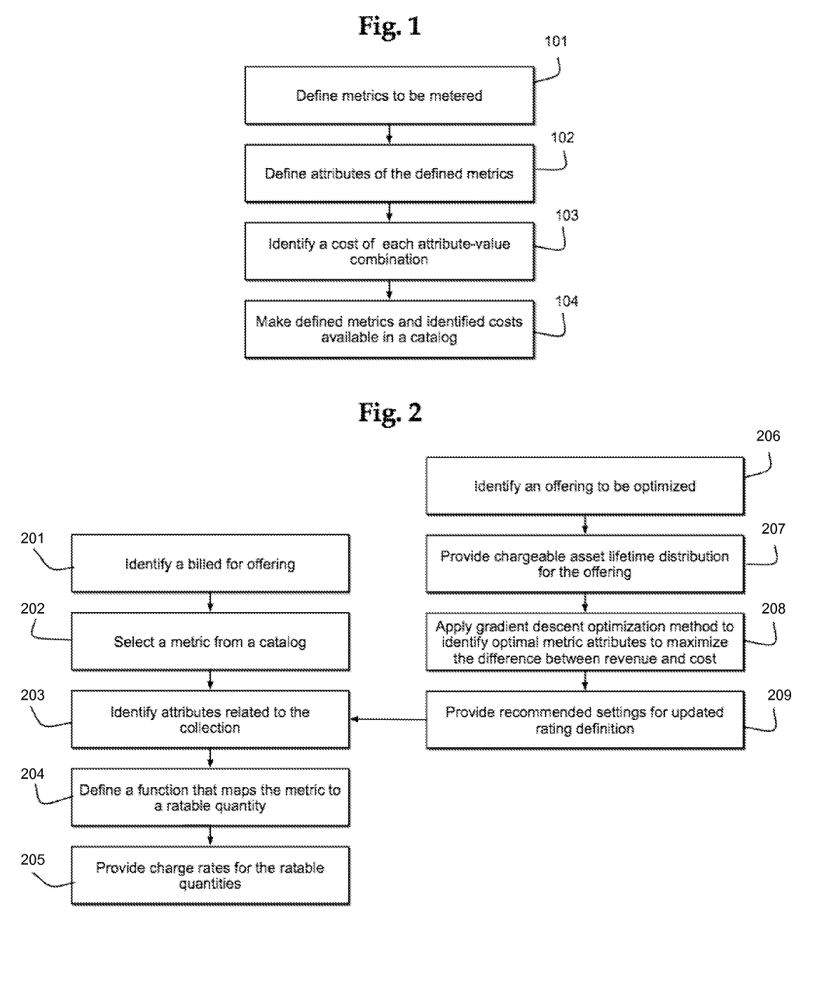

More particularly, an exemplary method for cost characteristic definition is shown in FIG. 1. According to FIG. 1, a cost characteristic may be defined by defining or identifying metrics to be metered (101), defining or identifying attributes of the metrics to be metered (102), identifying a cost of each attribute-value combination (103) and generating a catalog including the defined metrics and identified costs (104).

According to an embodiment of the present disclosure, rating and billing services templates may be defined, which can be configured according to the needs of a specific pricing of a business or production offering. The offering may include list prices and other default parameters. The rating and billing services template may include different customizable usage record formats, customizable rating logic and related parameterizations, associated data gathering costs, and associated revenue and profit from the metered data. The rating and billing services template may be reused for the different offerings. Exemplary rating and billing services template may define a p*q (price multiplied by quantity) rating of resource consumption, a tiered rating (varying the rate based on total quantity), etc.

An exemplary method for defining a charge characteristic is shown on the left side of FIG. 2 and includes identifying a offering being billed for (201), selecting a metric from a catalog (202) (see FIG. 1), identifying attributes related to the collection (203), defining a function that maps the metric to a ratable quantity (204), and providing charge rates for the ratable quantities (205).

More particularly, an exemplary method for metering optimization and charge characteristic definition is shown in FIG. 2. An exemplary method for metering optimization is shown on the right side of FIG. 2 and includes identifying an offering (206), providing a chargeable asset lifetime distribution for the offering (e.g., monthly) (207), identifying optimal metric attributes to maximize (or minimize) a difference between revenue and cost (208) or another performance indicator, and providing recommended settings for a rating definition (209). The chargeable asset lifetime distribution may include data or statistical information about the frequency, duration, and volume of asset usage. The recommended settings for the rating definition may be output to a method or routine for defining the charge characteristic, and may be used in the identification of attributes, for example.

According to an embodiment of the present disclosure, an objective function, e.g., the gradient descent optimization of block 208, may be defined in terms of cost and revenue. For example, the object function may balance cost and revenue to satisfy a goal.

According to an embodiment of the present disclosure, an application program interface (API) may be exposed allowing the offering to set up its rating and billing context inside of the rating and billing services template (e.g., customers, entitlements, prices etc.), upload usage records and obtain ratings for the usage records, generate rated usage data, apply extract, transform, load (ETL) processes to generate the appropriate billing format, and provide integration with billing backend systems (e.g., upload, notify, error handling).

According to an embodiment of the present disclosure, a data model includes a plurality of components including a metering definition (FIG. 1) and a service's rating definition (FIG. 2, left side). The data model may also include a rating definition optimization (FIG. 2, right side).

The metering definition, which may be service independent, can include performance indicators (PI) to be used as metrics, PI attributes related to the collection configuration, etc.

The PIs may include operating system (OS) statistics including a central processing unit (CPU), memory, and input/output (I/O). The PIs may further include application server statistics (e.g., number of active servlets, total load, number of restarts, etc.) and database statistics (e.g., table spaces, SQL statistics, number of run index, number of backups, etc.).

The PI attributes may include frequency, performance impact, risk (e.g., intrusive, destabilize the system, human danger, real or estimated cost, etc.), etc.

It should be understood that the PIs and PI attributes described here are merely exemplary, and that the particular examples described herein are not intended to be limiting. One of ordinary skill in the art would appreciate that various other PIs and PI attributes may be implemented.

The service's rating definitions may include metering PI, type (e.g., basic, tiered), frequency, shift, and related charges. More specifically, the metering PI may be identified by the offering management. The frequency may indicate an action (e.g., get), activation (e.g., on/off), usage (e.g., metered). The shift may indicate, for example, time of the day, week, or year. The related charges may indicate various different charges, including, for example, premium charges, reserved charges, supported charges, etc.

The service's rating definitions may include customer type (e.g., standard, custom, etc.) and the PI ranges and distribution. The PI ranges and distribution of OS parameters (e.g., CPU [Attribute, Distribution], memory [Attribute, Distribution], IO [Attribute, Distribution]), application server parameters (e.g., number of active servlets [Attribute, Distribution], total load [Attribute, Distribution], and number of restarts), and database parameters.

The optimization of a formulation draft includes the definition of valuations for service usage parameters, the definition of an objective function based on metering cost and revenue generated, and the exploration space of metering definition and rating definition combinations. The optimization may be performed using well-known non-linear optimization techniques such as gradient descent method.

In defining the valuations for service usage parameters a context may be considered. For example, in a bootstrap situation, expected values may be used, such as an industry average observed in other deployments. An example of such an industry average for service usage may include a parameter denoting frequency with which a user may request a virtual machine instance. The parameter may be an average provisioning frequency observed in an IBM Cloud system. In the case of a running system, parameter estimates may be used. The parameter estimates may be collected based on measurements.

In exploring a space of metering definition and rating definition combinations, for each combination an amortized metering cost and other attributes (e.g., risk) may be determined, wherein a combination maximizing the objective function may be selected.

Referring now to the optimization outcomes; optimal rating packages (e.g., which maximize a difference between the revenue from metered usage and the cost of metering) may be identified for the different types of customers may lead to the actionable tasks. These tasks may include deployment, configuration or implementation of metering PIs not existing in a current service, the optimization of metering PIs too costly in current service, and enablement of the package for use within the business or production offering.

Another optimization outcome may be applied once the service is in production, wherein system and marketing data may be dynamically updated (e.g., updating the optimal rating packages).

In yet another optimization outcome, customer constraints such as budget governance can be added to the above OFF-LINE optimization formulation in view of an ON-LINE rating package computation for tuning the rating and dynamic profitability adjustment.

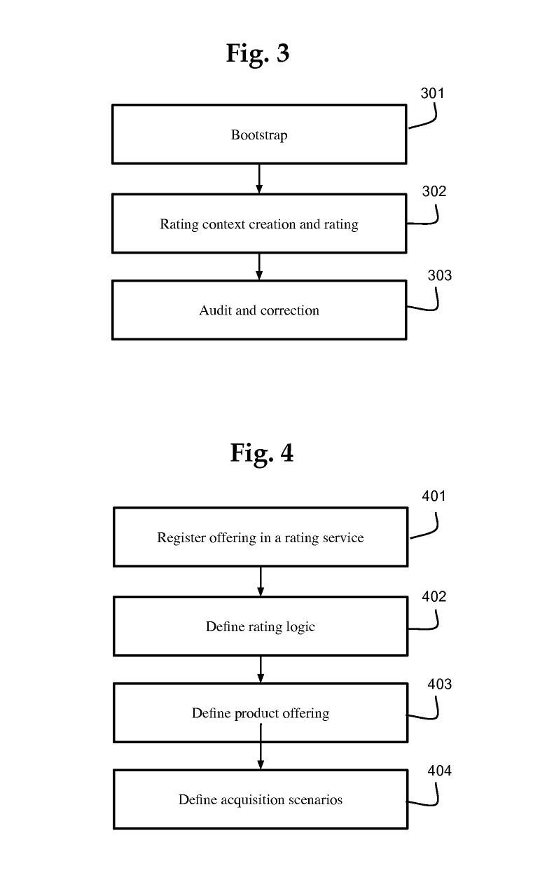

Referring to FIG. 3, rating service functionality may include a bootstrap phase 301, a rating context creation and rating phase 302, and an audit and correction phase 303.

The rating context may be a Cloud Computing & rating service. Referring to FIG. 4, in the bootstrap phase 301, a new offering may be registered in a rating service defining products which will be charged for and related usage record schema 401, defining a rating logic used to transform usage records into rated charges 402, defining product offerings 403, and defining acquisition scenarios (e.g., directory where service uploads usage files) 404.

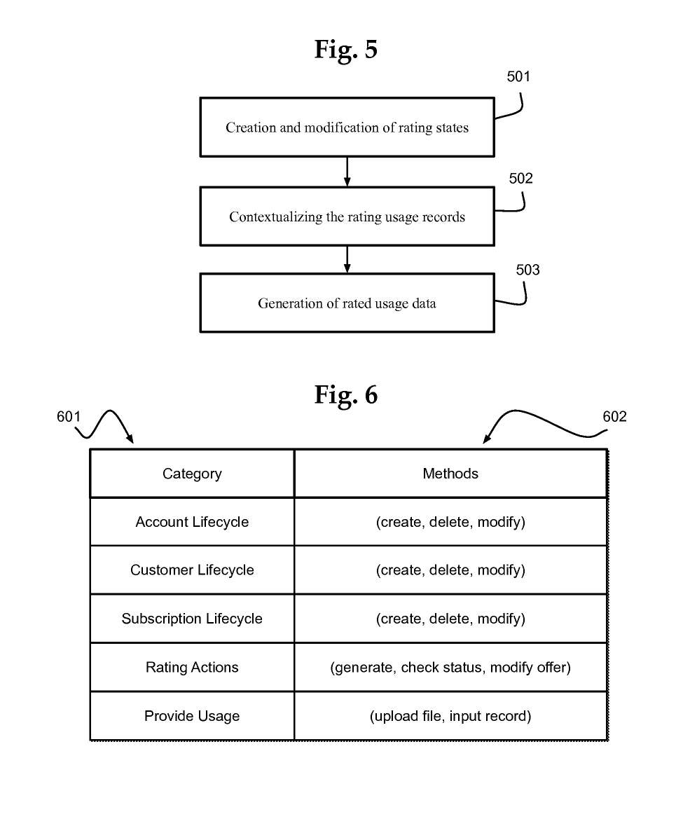

Referring to FIG. 5, the rating context creation and rating phase 302 may include the creation and modification of rating contexts for a contract of a registered offering 501. Here, customers, accounts, subscriptions, prices and other parameters may be created, modified and deleted (for example, to create, modify or delete a value of a tier n, where tier n is one of the 1 to m defined tiers, threshold for tiered rating). Tiered rating is based on varying price as a function of quantity consumed. For example, for a 2-tier rating model a tier 1 threshold is the consumption value at which price per unit of a resource consumed changes. For example, all usage below the tier 1 threshold may be charged at lower rate while all usage above the tier 1 threshold is charged at a higher rate. The system may include an API for rating context creation and rating phase. The rating context creation and rating phase 302 may include contextualizing the rating usage records 502. Here, usage records having a structure matching a registered definition may be accepted, and defined rating logic may be run. The rating model may be monitored, for example to track the rating of usage records, the rejection of usage records, etc. The rating context creation and rating phase 302 may include the generation of rated usage data 503, wherein invoices may be created for certain dates (e.g., all transactions not generated before some date), and wherein the rated usage data is generated. The generated rated usage data may be accessed by an offering in the form of a file or database access.

The audit and correction phase 303 may include monitoring and error correction. For example, auditing the operations and storing logs in a common audit database, post-rating changes to an offering definition, to a rating context, or both, re-submitting corrected usage records and re-rating usage data, and the re-creation of invoices and rated usage data. The monitoring and error correction may be implemented through an API and/or manual control/programming.

The monitoring and error correction 303 may include the capability to monitor for and correct offering definitions, rating contexts, rating runs, rated usage generation process, etc.

The system may offer API extensions of the rating service. For example, in the rating context creation and rating phase 302, rating “templates” may be created. The templates may be reused. For example, a rating service API may be extended to offer p*q pricing, tiered pricing, and tiered pricing with minimum templates. In an other example, the rating service API may be extended to allow creation of new rating logic based on reusing of the templates

Rating context creation and rating execution is exemplified in FIG. 6, which depicts an exemplary set of API categories 601. Specific API interfaces (e.g., defined for creating a customer object, deleting an existing subscription, modifying an offers parameters, uploading a usage file for rating, etc.) in these categories may be exposed, allowing an offering to configure its rating model within the metering and rating framework using defined methods 602, such as create, delete, modify, generate, check status, modify offer, upload file, input record, etc.

The rating service may allow for programmatic corrections, wherein corrective actions may be automated.

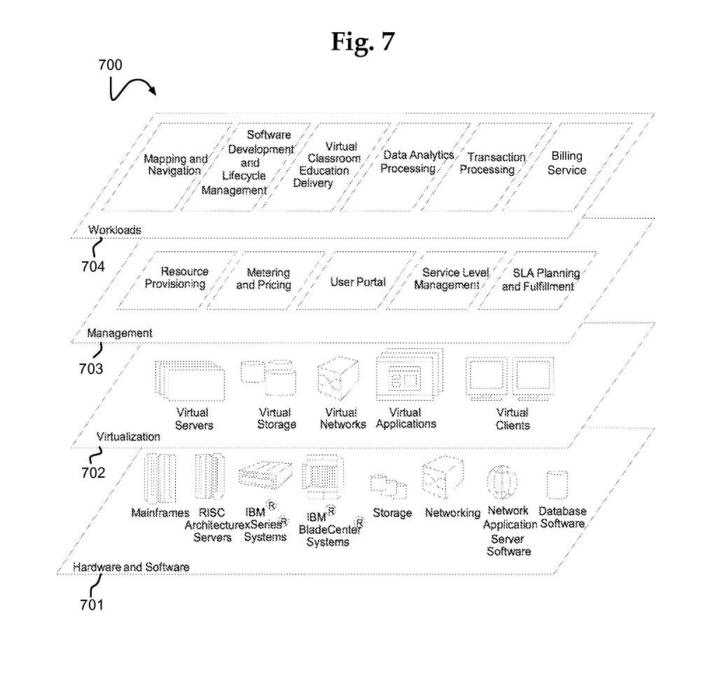

One exemplary implementation of a rating service includes billing service functionality deployed in a cloud environment (see FIG. 7).

It is understood in advance that although this disclosure includes a detailed description of a rating and metering system based on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service.

The billing service may following the method of FIG. 3 including the bootstrap phase 301 including the registering new offerings in the billing service, a billing context creation and operation phase 302, and an audit and corrections phase 303.

Referring to the registration of new offerings in the billing service in the bootstrap phase 301, a rated usage record format may be defined, a billing record format may be defined, and an offering configuration may be defined in a billing backend system (e.g., source, product, calendar, etc.).

The billing context creation and operation phase 302 may include the creation and modification of billing contexts for a contract of a registered offering. Creation, modification, and deletion of customers and contract registration parameters (e.g., customer number/type, contract number/type, work number, charge type, etc.).

The billing record generation may be performed in a defined context. Here, rating usage records with structure matching the registration definition may be accepted. The billing record generation includes providing validation and notification functionality (e.g., allowing the user to inspect the results, identify which billing records were erroneous, and introduce required corrections, etc.). This may be in the form of automated policy based review of the usage and rated content, provisions to allow a manual inspection of the usage and rated content and the ability to amend the content.

The generation of billing record data includes creating billing data based on a calendar, providing automatic upload or manual access to data for the billing backend system, and sending data to appropriate backend systems for invoice generation.

The audit and corrections phase 303 includes monitoring and error correction. Here, auditing the operations and storing logs in the common audit database and providing validation and notification functionality (e.g., email to the business of which billing records were valid, which were invalid and the reason why the billing records were invalid, etc.).

Referring to FIG. 7, a set of functional abstraction layers provided by cloud computing environment 700 providing billing service functionality is shown. It should be understood in advance that the components, layers, and functions shown in FIG. 5 are intended to be illustrative only and embodiments of the invention are not limited thereto. As depicted, the following layers and corresponding functions are provided:

Hardware and software layer 701 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 702 provides an abstraction layer from which the following examples of virtual entities may be provided: virtual servers; virtual storage; virtual networks, including virtual private networks; virtual applications and operating systems; and virtual clients.

In one example, management layer 703 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses.

Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Work loads layer 704 provides examples of functionality for which the cloud computing environment may be utilized. Examples of workloads and functions which may be provided from this layer include: mapping and navigation; software development and lifecycle management; virtual classroom education delivery; data analytics processing; transaction processing; and billing service functionality.

The methodologies of embodiments of the disclosure may be particularly well-suited for use in an electronic device or alternative system. Accordingly, embodiments of the present disclosure may take the form of an entirely hardware embodiment or an embodiment combining software and hardware aspects that may all generally be referred to herein as a “processor”, “circuit,” “module” or “system.” Furthermore, embodiments of the present disclosure may take the form of a computer program product embodied in one or more computer readable medium(s) having computer readable program code stored thereon.

Any combination of one or more computer usable or computer readable medium(s) may be utilized. The computer-usable or computer-readable medium may be a computer readable storage medium. A computer readable storage medium may be, for example but not limited to, an electronic, magnetic, optical, electromagnetic, infrared, or semiconductor system, apparatus, device, or any suitable combination of the foregoing. More specific examples (a non-exhaustive list) of the computer-readable storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus or device.

Computer program code for carrying out operations of embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Embodiments of the present disclosure are described above with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions.

These computer program instructions may be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

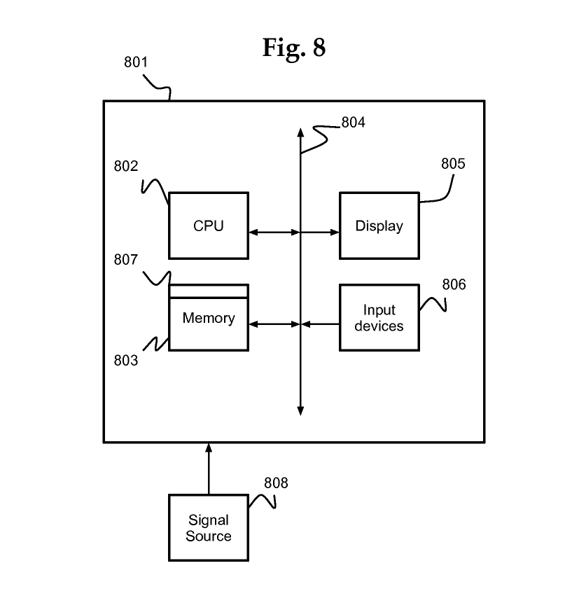

For example, FIG. 8 is a block diagram depicting an exemplary computer system for performing a network trace-based user re-identification method. The computer system 801 may include a processor 802, memory 803 coupled to the processor (e.g., via a bus 804 or alternative connection means), as well as input/output (I/O) circuitry 805-806 operative to interface with the processor 802. The processor 802 may be configured to perform one or more methodologies described in the present disclosure, illustrative embodiments of which are shown in the above figures and described herein. Embodiments of the present disclosure can be implemented as a routine 807 that is stored in memory 803 and executed by the processor 802 to process the signal from the signal source 808. As such, the computer system 801 is a general-purpose computer system that becomes a specific purpose computer system when executing the routine 807 of the present disclosure.

It is to be appreciated that the term “processor” as used herein is intended to include any processing device, such as, for example, one that includes a central processing unit (CPU) and/or other processing circuitry (e.g., digital signal processor (DSP), microprocessor, etc.). Additionally, it is to be understood that the term “processor” may refer to a multi-core processor that contains multiple processing cores in a processor or more than one processing device, and that various elements associated with a processing device may be shared by other processing devices.

The term “memory” as used herein is intended to include memory and other computer-readable media associated with a processor or CPU, such as, for example, random access memory (RAM), read only memory (ROM), fixed storage media (e.g., a hard drive), removable storage media (e.g., a diskette), flash memory, etc. Furthermore, the term “I/O circuitry” as used herein is intended to include, for example, one or more input devices (e.g., keyboard, mouse, etc.) for entering data to the processor, and/or one or more output devices (e.g., printer, monitor, etc.) for presenting the results associated with the processor.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Although illustrative embodiments of the present disclosure have been described herein with reference to the accompanying drawings, it is to be understood that the disclosure is not limited to those precise embodiments, and that various other changes and modifications may be made therein by one skilled in the art without departing from the scope of the appended claims.

1. A computer program product for creating a configurable model for rating and metering resource usage, the computer program product comprising:
a computer readable storage medium having computer readable program code embodied therewith, the computer readable program code comprising:
computer readable program code configured to create at least one rating context for a contract of a registered offering, wherein the registered offering is a resource;
computer readable program code configured to monitor the resource usage to create a usage record;
computer readable program code configured to contextualize the usage record of the resource;
computer readable program code configured to generate rated usage data according to the usage record;
computer readable program code configured to represent a cost of metering the resource usage, based on the rated usage data, for each of a plurality of varying metrics; and
computer readable program code configured to select an optimum metric, from the plurality of varying metrics, for metering the resource usage by optimizing for a desired criteria.

2. The computer program product of claim 1, wherein each of the plurality of varying metrics is an indicator of usage or performance.

3. The computer program product of claim 2, wherein the indicators of usage or performance include a frequency.

4. The computer program product of claim 1, wherein the the desired criteria includes balancing a collection cost impact and a revenue potential.

5. The computer program product of claim 1, wherein the the desired criteria includes balancing an impact cost and a revenue potential.

6. The computer program product of claim 2, wherein the indicators of usage or performance include a detail level.

7. The computer program product of claim 5, wherein the impact cost is a performance degradation of the resource.

8. The computer program product of claim 5, wherein the impact cost is a risk factor associated with the plurality of varying metrics.

9. The computer program product of claim 1, wherein the cost of metering the resource usage includes a chargeback allocated to an expense originating entity.

10. The computer program product of claim 1, wherein the cost of metering the resource usage includes a royalty measurement.

11. A computer program product for creating a configurable model for rating and metering resource usage, the computer program product comprising:
a computer readable storage medium having computer readable program code embodied therewith, the computer readable program code comprising:
computer readable program code configured to monitor at least one rating context for a contract of a registered offering, wherein the registered offering is a resource;
computer readable program code configured to contextualize a usage record of the resource;
computer readable program code configured to generate rated usage data according to the usage record; and
computer readable program code configured to optimize a cost of generating the rated usage data and a revenue generated by the registered offering.

12. The computer program product of claim 11, wherein the optimization is performed according to a frequency metric.

13. The computer program product of claim 11, wherein the optimization is performed according to a risk metric.

14. The computer program product of claim 11, wherein the optimization is performed according to a performance impact metric.

15. The computer program product of claim 11, wherein the optimization is performed according to a detail level metric, wherein the detail level corresponds to a detail level of the at least one rating context being monitored.
